(19) United States
(12) Patent Application Publication
(10) Pub. No.: US 2026/0093405 A1
(43) Pub. Date: Apr. 2, 2026

(54) STORAGE DEVICE CONTROL METHOD AND ELECTRONIC DEVICE USING THE STORAGE DEVICE CONTROL METHOD

(71) Applicant: MEDIATEK INC, Hsinchu City (TW)

(72) Inventors: Chi-Cheng Liao, Hsinchu City (TW); Kuan-Ting Lin, Hsinchu City (TW); Jia-You Chuang, Hsinchu City (TW); Chih-Ming Wang, Hsinchu City (TW)

(73) Assignee: MEDIATEK INC, Hsinchu City (TW)

(21) Appl. No.: 19/336,519

(22) Filed: Sep. 23, 2025

Related U.S. Application Data
(60) Provisional application No. 63/699,986, filed on Sep. 27, 2024.

(51) Int. Cl. G06F 3/06

(52) U.S. Cl. CPC G06F 3/0625; G06F 3/0659; G06F 3/0673

(57) ABSTRACT

A storage device control method, for controlling an operating level of a storage device, comprising: a control circuit acquiring a first bandwidth requirement of a target device; the control circuit acquiring a first latency requirement of the target device, wherein the first latency requirement indicates a first maximum allowed latency for the target device; and the control circuit setting the operating level to a first operating level according to the first bandwidth requirement and the first latency requirement.

### CROSS REFERENCE TO RELATED APPLICATIONS

This application claims the benefit of U.S. Provisional Application No. 63/699,986, filed on Sep. 27, 2024. The content of the application is incorporated herein by reference.

### BACKGROUND

The present application relates to a storage device control method and an electronic device, and particularly relates to a storage device control method and an electronic device which can set an operating level of the storage device according to a latency requirement of a target device.

In the related art, each electronic module in an electronic device will make bandwidth requirements on a DRAM to meet its data transmission needs. After receiving bandwidth requirements, the DRAM may increase its operating level to make its bandwidth meet the bandwidth requirements. When the DRAM operates at a higher operating level, it consumes more power. However, in some cases, electronic modules may generate excessively high bandwidth requirements to meet their data transmission latency requirements, resulting in unnecessary power consumption.

Therefore, a new control mechanism for control the DRAM is needed.

### SUMMARY

One objective of the present application is to provide a storage device control method which can set an operating level of the storage device according to a latency requirement.

Another objective of the present application is to provide an electronic device which can set an operating level of the storage device according to a latency requirement.

One embodiment of the present application discloses a storage device control method, for controlling an operating level of a storage device, comprising: a control circuit acquiring a first bandwidth requirement of a target device; the control circuit acquiring a first latency requirement of the target device, wherein the first latency requirement indicates a first maximum allowed latency for the target device; and the control circuit setting the operating level to a first operating level according to the first bandwidth requirement and the first latency requirement.

Another embodiment of the present application discloses an electronic device, comprising: a storage device; a target device; and a control circuit, configured to acquire a first bandwidth requirement and a first latency requirement of a target device, and configured to set the operating level to a first operating level according to the first bandwidth requirement and the first latency requirement; wherein the first latency requirement indicates a first maximum allowed latency for the target device.

In view of above-mentioned embodiments, the operating level of the storage device may be set according to latency requirement of a target device which provides the bandwidth requirement. By this way, the selection of the operating level can be optimized and power consumption can be reduced thereby.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device according to one embodiment of the present application.

FIG. 2A, FIG. 2B and FIG. 3 are schematic diagrams illustrating examples of setting an operating level of the storage device, according to embodiments of the present application.

FIG. 4 is a flow chart illustrating a storage device control method, according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

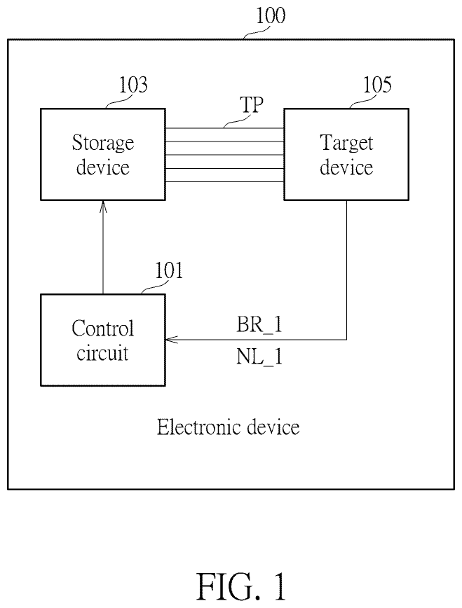

FIG. 1 is a block diagram illustrating an electronic device according to one embodiment of the present application. As shown in FIG. 1, the electronic device 100 comprises a control circuit 101, a storage device 103 and a target device 105. The electronic device 100 may be any kind of electronic device, for example, a mobile phone, a laptop, or a notebook. The control circuit 101 may be any circuit with a processing function, such as a CPU or a MCU. In following embodiments, the storage device 103 is a DRAM. However, the storage device 103 may be any other type of storage device. The target device 105 may be any device which can transmit data. In one embodiment, the target device 105 is a CM, a GPU (Graphics Processing Unit), or a display. CM, which is an abbreviation of a CPU or MEMORY manager, means a module which can manage a CPU or a memory. For example, the CM may monitor the memory bandwidth or the memory latency, and adjusts the memory bandwidth according to the memory bandwidth or the memory latency.

Also, in following embodiments, the term “bandwidth” means the total throughput of transmission path TP between the storage device 103 and the target device 105. Besides, in following embodiments, the term “latency” means the latency caused by the transmission path TP between the storage device 103 and the target device 105. The latency may be caused by, for example, the transmission lines, the logic units, or the device contained in the transmission path TP. Afterwards, the control circuit 101 sets the operating level of the storage device 103 to a first operating level according to the first bandwidth requirement BR 1 and the first latency requirement NR 1. The first latency requirement NR 1 indicates a first maximum allowed latency for the target device. In other words, the first latency requirement NR 1 indicates that the latency should be less than the first maximum allowed latency. The higher the first latency requirement NR 1 is, the lower the first maximum allowed latency is. Details of the operating level will be described in following description.

In the embodiment of FIG. 1, the control circuit 101 acquires a first bandwidth requirement BR_1 of the target device 105, and acquires a first latency requirement NR_1 of the target device 105. In one embodiment, the control circuit 101 acquires the first latency requirement NR_1 from software which controls the target device 105. In other words, the software may compute the first latency requirement NR_1 based on the first bandwidth requirement BR_1. In another embodiment, the control circuit 101 acquires the first latency requirement from a pre-record table which stores a relation between a system throughput bandwidth and a latency. However, such software can be other than the software that controls the target device.

For example, in following Table 1, relations between a system throughput bandwidth and a latency are recorded. In such case, the control circuit 101 acquires the first latency requirement NR_1 according to the relations recorded in Table 1.

TABLE 1

| Target Device | Band Width | | Latency Threshold |
|---|---|---|---|
| CM | 5 | G | P ms |
| GPU | 15 | G | Q ms |
| Display | 2 | G | R ms |

For example, if the first bandwidth requirement BR_1 for the CM is 5G, the corresponding first latency requirement NR_1 means the latency threshold is P ms. In other words, CM requires that the latency for data transmission thereof must be lower than P ms. For another example, if the first bandwidth requirement BR_1 for the GPU is 15G, the corresponding first latency requirement NR_1 means the latency threshold is Q ms. In other words, CM requires that the latency for data transmission thereof must be lower than Q ms. Please note, Table 1 is only an example for explaining, the table which stores relations between the first bandwidth requirement BR_1 and the first latency requirement NR_1 is not limited to Table 1.

Different target devices may have different latency requirements. For example, the target device may have a high latency requirement if the target device is a GPU. Also, the target device may have a low latency requirement if the target device is a CPU.

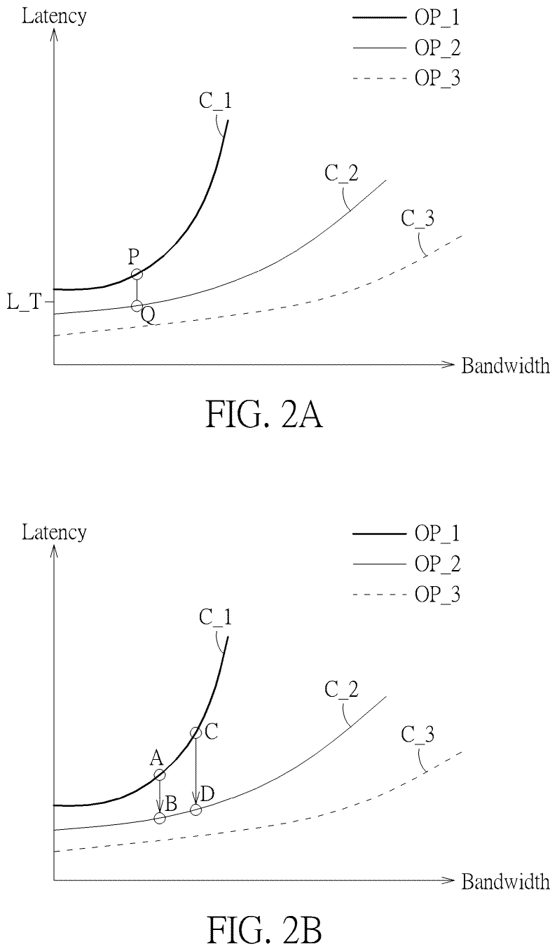

In following descriptions, several embodiments are provided to explain the operations of the electronic device in FIG. 1. FIG. 2A, FIG. 2B and FIG. 3 are schematic diagrams illustrating examples of setting an operating level of the storage device, according to embodiments of the present application. Please refer to FIG. 2A, which illustrates relation curves C_1, C_2, C_3. The relation curves C_1, C_2, C_3 represent the relations between the bandwidth and the latency, while the storage device 103 operating at different operation levels OP_1, OP_2, OP_3. For example, when the storage device 103 operates at the operation level OP_1, the relations between the bandwidth and the latency are the relations shown in the relation curves C_1. For another example, when the storage device 103 operates at the operation level OP_2, the relations between the bandwidth and the latency are the relations shown in the relation curves C_2. The operating level OP_3 is higher than the operating level OP_2, and the operating level OP_2 is higher than the operating level OP_1.

The higher the operating level, the higher the performance of the storage device 103 is. For example, the storage device 103 has a higher bandwidth while having the same latency. However, the higher the operating level, the higher the power consumption of the storage device 103 is. The operating level can be adjusted by adjusting the operating parameters of the storage device. For example, the operating level can be adjusted by increasing the frequency of the clock signal used by the storage device 103.

In one embodiment, besides the above-mentioned first bandwidth requirement BR_1 and the first latency requirement NR_1, the control circuit 101 further acquires a second bandwidth requirement and a second latency requirement indicating a second maximum allowed latency for the target device lower than the first maximum allowed latency. In other words, the second latency requirement is higher than the first latency requirement NR_1. In such case, the control circuit 101 sets the operating level to a second operating level higher than the first operating level when the first operating level cannot satisfy at least one of the second bandwidth requirement and the second latency requirement.

For example, in the embodiment of FIG. 2A, the storage device 103 may operate at different operating levels OP_1, OP_2, OP_3. The storage device 103 operates at a point Q of the operating level OP_1 (first operating level) corresponding to the above-mentioned first bandwidth requirement BR_1 and the first latency requirement NR_1 and then receives the second bandwidth requirement and the second latency requirement.

However, the required latency of the second latency requirement is lower than the latency which the operating level OP_1 can provide. In such case, the control circuit 101 sets the storage device 103 from the operating level OP_1 to the operating level OP_2. In other words, the storage device 103 changes to operate at the point Q in the embodiment of FIG. 2A

In one embodiment, the control circuit 101 can delay the time for raising up the operating level according to the latency requirement, to reduce power consumption. As above-mentioned, besides the above-mentioned first bandwidth requirement BR_1 and the first latency requirement NR_1, the control circuit 101 may further acquire a second bandwidth requirement, and a second latency requirement. In one embodiment, the first bandwidth requirement BR_1 and the second bandwidth requirement may require identical bandwidths, and the second latency requirement is higher than the first latency requirement NR_1.

In such case, the control circuit 101 sets the operating level from the operating level OP_1 (the first operating level) to the operating level OP_2 (the second operating level) when a used bandwidth of the storage device reaches X % of a maximum bandwidth, which corresponds to the operating level OP_1, of the storage device, responding to receiving the first bandwidth requirement BR_1 and the first latency requirement NR_1. Also, the control circuit 101 sets the operating level from the operating level OP_1 to the operating level OP_2 when the used bandwidth of the storage device reaches Y % of the maximum bandwidth of the storage device, responding to receiving the second bandwidth requirement and the second latency requirement. X and Y are positive rational numbers and Y is less than X. For example, in following embodiment, X is 90 and Y is 80.

Briefly, if the target device 105 needs a low latency (i.e., the latency requirement thereof is high), the control circuit 101 needs to increase the operating level more early (e.g., when the used bandwidth reaches 80% of the maximum bandwidth), to make sure the latency requirement is meet. On the contrary, if the target device can suffer a high latency (i.e., the latency requirement thereof is low), the control circuit 101 may delay the time for increasing the operating level (e.g., until the used bandwidth reaches 90% of the maximum bandwidth). Take the embodiment shown in FIG. 2B for example, if the target device 105 needs a low latency, the control circuit 101 increases the operating level at the point A of the operating level OP_1 (i.e., the used bandwidth reaches 80% of the maximum bandwidth) to a point B of the operating level OP_2. Further, if the target device 105 can suffer a high latency, the control circuit 101 increases the operating level at the point C of the operating level OP_2 (i.e., the used bandwidth reaches 80% of the maximum bandwidth) to a point D of the operating level OP_2.

In one embodiment, several operating levels may meet the first bandwidth requirement BR_1 and the first latency requirement NR_1 received by the control circuit 101. In such case, a lowest operating level can be selected, to reduce the power consumption. As shown in FIG. 3, the first bandwidth requirement BR_1 requires a target bandwidth B T and the first latency requirement NR_1 requires a target latency L_T. In such case, the operating levels OP_1, OP_2 and OP_3 all meet the first bandwidth requirement BR_1 and the first latency requirement NR_1.

More specifically, when the storage device 103 operates at the operating level OP_1, the bandwidth is the bandwidth B 1 larger than the target bandwidth B T when the latency is the target latency L_T. Similarly, when the storage device 103 operates at the operating level OP_2, the bandwidth is the bandwidth B 2 larger than the target bandwidth B T when the latency is the target latency L_T. Accordingly, the operating levels OP_1 and OP_2 meet the first bandwidth requirement BR_1 and the first latency requirement NR_1. In such case, the operating level of the storage device 103 is set to be the lowest one of the operating levels which meets the first bandwidth requirement BR_1 and the first latency requirement NR_1. Accordingly, in the embodiment of FIG. 3, the operating level OP_1 is selected, thereby the power consumption can be reduced.

The embodiment illustrated in FIG. 3 can be summarized as:

The transmission path TP has a first bandwidth and a first latency when the storage device 103 operates at a first candidate operating level, wherein the first bandwidth b meets the first bandwidth requirement and the first latency meets the first latency requirement. For example, when the storage device 103 operates at the operating level OP_1 in FIG. 3, the transmission path TP has a first bandwidth B_1 while having a first latency (the target latency L_T).

Similarly, the transmission path TP has a second bandwidth B 2 and the first latency when the storage device 103 operates at a second candidate operating level (e.g., OP_2). The second bandwidth is larger than the first bandwidth and meets the first bandwidth requirement. The control circuit 101 selects the first candidate operating level as the first operating level.

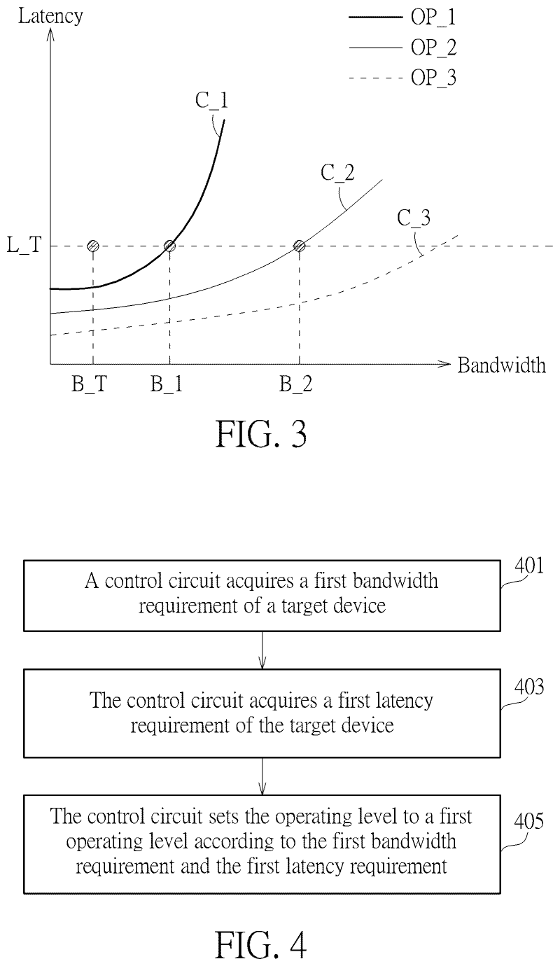

In view of above-mentioned embodiments, a storage device control method can be acquired, which is for controlling an operating level of a storage device. The storage device control method show in FIG. 4 comprises:

### Step 501

A control circuit (e.g., the control circuit 101) acquires a first bandwidth requirement (e.g., the first bandwidth requirement BR_1) of a target device (e.g., the target circuit 105).

### Step 503

The control circuit acquires a first latency requirement (e.g., the first latency requirement NL_1) of the target device.

The first latency requirement NL 1 indicates a first maximum allowed latency for the target device

### Step 505

The control circuit sets the operating level to a first operating level according to the first bandwidth requirement and the first latency requirement.

In view of above-mentioned embodiments, the operating level of the storage device may be set according to latency requirement of a target device which provides the bandwidth requirement. By this way, the selection of the operating level can be optimized and power consumption can be reduced thereby.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage device control method, for controlling an operating level of a storage device, comprising:
a control circuit acquiring a first bandwidth requirement of a target device;
the control circuit acquiring a first latency requirement of the target device, wherein the first latency requirement indicates a first maximum allowed latency for the target device; and
the control circuit setting the operating level to a first operating level according to the first bandwidth requirement and the first latency requirement.

2. The storage device control method of claim 1, further comprising:
the control circuit further acquiring a second bandwidth requirement and a second latency requirement indicating a second maximum allowed latency for the target device lower than the first maximum allowed latency, wherein the control circuit sets the operating level to a second operating level higher than the first operating level when the first operating level cannot satisfy at least one of the second bandwidth requirement and the second latency requirement.

3. The storage device control method of claim 2,
wherein the first bandwidth requirement and the second bandwidth requirement requires identical bandwidths;
wherein the control circuit sets the operating level to the second operating level when a used bandwidth of the storage device reaches X % of a maximum bandwidth corresponding to the first operating level of the storage device, responding to receiving the first bandwidth requirement and the first latency requirement;
wherein the control circuit sets the operating level to the second operating level when the used bandwidth of the storage device reaches Y % of the maximum bandwidth corresponding to the first operating level of the storage device, responding to receiving the second bandwidth requirement and the second latency requirement;
X and Y are positive rational numbers and Y is less than X.

4. The storage device control method of claim 1,
wherein a transmission path between the storage device and the target device has a first bandwidth and a first latency when the storage device operates at a first candidate operating level, wherein the first bandwidth meets the first bandwidth requirement and the first latency meets the first latency requirement;
wherein the transmission path has a second bandwidth and the first latency when the storage device operates at a second candidate operating level, wherein the second bandwidth is larger than the first bandwidth and meets the first bandwidth requirement;
wherein the control circuit selects the first candidate operating level as the first operating level.

5. The storage device control method of claim 1, wherein the control circuit acquires the first latency requirement from software which controls the target device.

6. The storage device control method of claim 1, wherein the control circuit determines the first operating level based on a pre-record table which stores a relation between a system throughput bandwidth and a latency.

7. The storage device control method of claim 1, wherein the target device is a CPU or MEMORY manager, a GPU (Graphics Processing Unit), or a display.

8. The storage device control method of claim 1, wherein the storage device is a DRAM.

9. An electronic device, comprising:
a storage device;
a target device; and
a control circuit, configured to acquire a first bandwidth requirement and a first latency requirement of a target device, and configured to set the operating level to a first operating level according to the first bandwidth requirement and the first latency requirement;
wherein the first latency requirement indicates a first maximum allowed latency for the target device.

10. The electronic device of claim 9, wherein the control circuit further acquires a second bandwidth requirement and a second latency requirement indicating a second maximum allowed latency for the target device lower than the first maximum allowed latency, wherein the control circuit sets the operating level to a second operating level higher than the first operating level when the first operating level cannot satisfy at least one of the second bandwidth requirement and the second latency requirement.

11. The electronic device of claim 10,
wherein the first bandwidth requirement and the second bandwidth requirement requires identical bandwidths;
wherein the control circuit sets the operating level to the second operating level when a used bandwidth of the storage device reaches X % of a maximum bandwidth corresponding to the first operating level of the storage device, responding to receiving the first bandwidth requirement and the first latency requirement;
wherein the control circuit sets the operating level to a second operating level when the used bandwidth of the storage device reaches Y % of the maximum bandwidth corresponding to the first operating level of the storage device, responding to receiving the second bandwidth requirement and the second latency requirement;
X and Y are positive rational numbers and Y is less than X.

12. The electronic device of claim 9, further comprising a transmission path between the storage device and the target device;
wherein the transmission path has a first bandwidth and a first latency when the storage device operates at a first candidate operating level, wherein the first bandwidth meets the first bandwidth requirement and the first latency meets the first latency requirement;
wherein the transmission path has a second bandwidth and the first latency when the storage device operates at a second candidate operating level, wherein the second bandwidth is larger than the first bandwidth and meets the first bandwidth requirement;
wherein the control circuit selects the first candidate operating level as the first operating level.

13. The electronic device of claim 9, wherein the control circuit acquires the first latency requirement from software which controls the target device.

14. The electronic device of claim 9,
wherein the control circuit determines the first operating level based on a pre-record table which stores a relation between a system throughput bandwidth and a latency.

15. The electronic device of claim 9, wherein the target device is a CPU or MEMORY manager, a GPU (Graphics Processing Unit), or a display.

16. The electronic device of claim 9, wherein the storage device is a DRAM.
